(19) United States
(12) Patent Application Publication
(10) Pub. No.: US 2015/0142222 A1
(43) Pub. Date: May 21, 2015

(54) APPARATUS AND METHOD FOR TRACING FLIGHT PLAN STATUS

(71) Applicant: ELECTRONICS AND TELECOMMUNICATIONS RESEARCH INSTITUTE, Daejeon-city (KR)

(72) Inventors: Byeong-Cheol CHOI, Daejeon (KR); Seoung-Hyeon LEE, Daejeon (KR); Deok-Gyu LEE, Yongin-si (KR); Yong-Kyun KIM, Daejeon (KR); Jong-Wook HAN, Daejeon (KR); Hyo-Dal PARK, Incheon (KR)

(73) Assignee: ELECTRONICS AND TELECOMMUNICATIONS RESEARCH INSTITUTE, Daejeon-city (KR)

(21) Appl. No.: 14/542,743

(22) Filed: Nov. 17, 2014

(30) Foreign Application Priority Data
Nov. 19, 2013 (KR) 10-2013-0140887

(51) Int. Cl. G08G 5/00

(52) U.S. Cl. CPC G08G 5/0034; G08G 5/0017
USPC 701/3

(57) ABSTRACT

An apparatus and a method for tracing a flight plan status are disclosed. The apparatus for tracing a flight plan status includes: a flight plan structure generation unit configured to generate a flight plan status transition structure based on received flight plan information; a flight plan setting unit configured to set a flight plan status based on a flight message transferred through an aeronautical fixed telecommunication network; and a flight plan tracing unit configured to trace the flight plan status included in the flight plan status transition structure based on the set flight plan status.

### CROSS REFERENCE TO RELATED APPLICATION

This application claims the benefit of Korean Patent Application No. 10-2013-0140887, filed on Nov. 19, 2013, which is hereby incorporated by reference in its entirety into this application.

### BACKGROUND OF THE INVENTION

1. Technical Field

The present invention relates to an apparatus and a method for tracing a flight plan status, and more particularly, to an apparatus and a method for tracing a flight plan status capable of providing a flight plan status transition structure for tracing a life-cycle of a flight plan status in real time.

2. Description of the Related Art

Generally, an air traffic control means services of an air-traffic control center which controls take off and landing order, timing, and method of all the aircrafts which are on the ground or is in flight so as to prevent aircrafts from colliding with each other, prevent an aircraft from colliding with obstacles, provide promotion and order maintenance of air traffic. The air traffic control is classified into an aerodrome control which is a control service performed on people who are engaged in aircrafts navigated around a moving area within an airport and an aerodrome and the corresponding aerodrome, an approach control which is a control service performed on instrument flying aircrafts arriving and departing at and from a competent airport positioned within a terminal control area, an air route control which is a control service segmenting between instrument flying aircrafts flying on an air route and providing information to the instrument flying aircrafts, and the like.

Recently, owing to the increase in light aircrafts and private aircrafts in addition to the increase in large aircrafts of airlines, and the like, air traffic tends to be increased dramatically. Naturally, an aircraft accident rate tends to be increased with the increase in air traffic. Therefore, with the increase in importance of the air traffic control, a technology to enhance accuracy of the air traffic control has been required.

However, since the existing air traffic control depends on a departure time of aircrafts included in a flight plan, there is a problem in that the accuracy of the air traffic control is reduced and thus a feeling of uneasiness of passengers is increased.

Further, since the existing air traffic control does not provide accurate flight plan status management information of departing and arriving aircrafts, there is a problem in that a holding time of aircrafts is increased and thus the aircrafts waste fuel and time.

Therefore, to support the accurate air traffic control, a technology to rapidly and accurately provide the flight plan status management information of departing and arriving aircrafts to aircrafts and controllers has been required.

In connection with this, Korean Patent Application Publication No. 2011-0061292 discloses “Apparatus And Method For Managing Flight Plan Status For Air Traffic Control”.

### SUMMARY OF THE INVENTION

Accordingly, the present invention has been made keeping in mind the above problems occurring in the conventional art, and an object of the present invention is to provide an apparatus and a method for tracing a flight plan status capable of providing a flight plan status transition structure for tracing a life-cycle of a flight plan status in real time.

In accordance with an aspect of the present invention, there is provided an apparatus for tracing a flight plan status, including: a flight plan structure generation unit configured to generate a flight plan status transition structure based on received flight plan information; a flight plan setting unit configured to set a flight plan status based on a flight message transferred through an aeronautical fixed telecommunication network; and a flight plan tracing unit configured to display and trace the flight plan status included in the flight plan status transition structure based on the set flight plan status.

The flight plan information may include flight plan basic information which includes any one of a flight plan identifier, an aircraft identifier, a flight plan input date and time, a departure aerodrome, a destination aerodrome, a flight type, and any one of other flight plan information and flight plan time information which includes moving start time for aircraft departure, estimated time of departure, estimated time of arrival, actual time of departure, actual time of arrival, and a date of flight.

The flight plan structure generation unit may generate the flight plan status transition structure which includes a flight plan status of any one of first waiting, modeling, second prepared, departed, controlled, terminated, arrived, and deleted.

The first waiting may represent a waiting status before the flight plan information is received and the second prepared may represent a waiting status after the flight plan information is received.

The flight plan structure generation unit may generate the flight plan status transition structure which includes the controlled branched from the departed.

The flight plan structure generation unit may generate the flight plan status transition structure which includes the first waiting, the modeling, the second prepared, and terminated branched from the controlled.

The flight message may include any one of an emergency message, an aircraft moving message, a coordination message, a supplementary flight plan message, and a control message.

The apparatus for tracing a flight plan status may further include: a flight plan information management unit configured to store and manage the flight plan information, state change information of a flight plan, and final state change time information of a flight plan.

The apparatus for tracing a flight plan status may further include: an output unit configured to output the flight plan status transition structure at once and display and monitor the set flight plan status in the status transition structure in real time.

In accordance with another aspect of the present invention, there is provided a method for tracing a flight plan status, including: generating, by a flight plan structure generation unit, a flight plan status transition structure based on received flight plan information; setting, by a flight plan setting unit, a flight plan status based on a flight message transferred through an aeronautical fixed telecommunication network; and displaying and tracing, by a flight plan tracing unit, the flight plan status included in the flight plan status transition structure based on the set flight plan status.

In the generating of the flight plan status transition structure based on the received flight plan information, the flight plan status transition structure which includes a flight plan status of any one of first waiting before a flight plan is received, modeling, second prepared after the flight plan is received, departed, controlled, terminated, arrived, and deleted may be generated.

In the setting of the flight plan status based on the flight message transferred through the aeronautical fixed telecommunication network, the flight plan status may be set based on the flight message which includes any one of an emergency message, an aircraft moving message, a coordination message, a supplementary flight plan message, and a control message.

The method for tracing a flight plan status may further include: after the tracing of the flight plan status included in the flight plan status transition structure based on the set flight plan status, outputting the flight plan status transition structure at once and displaying and monitoring the set flight plan status in the status transition structure in real time.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram for describing a configuration of an apparatus for tracing a flight plan status according to an exemplary embodiment of the present invention;

FIG. 2 is a diagram for describing a flight plan status transition structure according to an exemplary embodiment of the present invention;

FIG. 3 is a diagram for describing flight plan management information which is stored and managed in the apparatus for tracing a flight plan status according to an exemplary embodiment of the present invention; and

FIG. 4 is a flow chart for describing a method for tracing a flight plan status according to an exemplary embodiment of the present invention.

### DESCRIPTION OF THE PREFERRED EMBODIMENTS

Hereinafter, exemplary embodiments of the present invention will be described in detail with reference to the accompanying drawings so that those skilled in the art may easily practice the present invention. It is to be noted that in adding reference numerals to elements of each drawing, like reference numerals refer to like elements even though like elements are shown in different drawings. Further, in describing exemplary embodiments of the present invention, well-known functions or constructions will not be described in detail since they may unnecessarily obscure the understanding of the present invention.

Hereinafter, an apparatus and a method for tracing a flight plan status according to exemplary embodiments of the present invention will be described in detail with reference to the accompanying drawings.

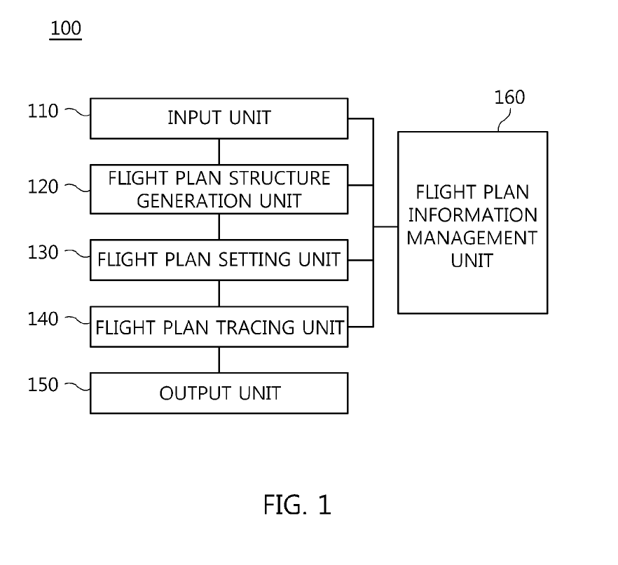

FIG. 1 is a diagram for describing a configuration of an apparatus for tracing a flight plan status according to an exemplary embodiment of the present invention.

Referring to FIG. 1, an apparatus 100 for tracing a flight plan status according to an exemplary embodiment of the present invention may largely include an input unit 110, a flight plan structure generation unit 120, a flight plan setting unit 130, a flight plan tracing unit 140, an output unit 150, and a flight plan information management unit 160.

The input unit 110 receives flight plan basic information and flight plan time information. That is, the input unit 110 receives flight plan basic information which includes any one of a flight plan identifier, an aircraft identifier, a flight plan input date and time, a departure aerodrome, a destination aerodrome, a flight plan type, and other flight plan information. Further, the input unit 110 receives flight plan time information which includes moving start time for aircraft departure, estimated time of departure, estimated time of arrival, actual time of departure, actual time of arrival, and a date of flight and which is determined depending on airport conditions and weather information (for example, weather, wind direction, wind velocity, and the like) of a point of departure.

The flight plan structure generation unit 120 generates the flight plan status transition structure based on the received flight plan information. The flight plan structure generation unit 120 generates the flight plan status transition structure which includes a flight plan status of any one of first waiting, modeling, second prepared, departed, controlled, terminated, arrived, and deleted.

The flight plan setting unit 130 sets the flight plan status based on flight messages transferred through an aeronautical fixed telecommunication network. Herein, the aeronautical fixed telecommunication network is connected to servers of a plurality of airports, control centers, airlines, and the like, in which the corresponding servers transmit and receive information required to navigate an aircraft through the aeronautical fixed telecommunication network. Further, the flight message includes any one of an emergency message, an aircraft moving message, a coordination message, a supplementary flight plan message, and a control message. The flight message classified for each usage includes the detailed message as described in the following Table 1.

TABLE 1
Type

| | |
|---|---|
| Emergency | ALR (Alarm Message), RCF (Radio Communication |
| Message | Failure Message) |
| Aircraft | FPL (Filed Flight Plan Message), CHG (Change Message), |
| Moving And | DLA (Delay Message), CNL (Cancel Message), DEP |
| Control | (Departure Message), ARR (Arrival Message) |
| Message | |
| Coordination | CPL (Current Flight Plan Message), EST (Estimated |
| Message | Message), CDN (Coordination Message), ACP (Acceptance |
| | Message), LAM (Logic Acknowledgement Message) |
| Additional | RQP (Request Flight Plan Message), RQS (Request |
| Message | Supplementary Flight Plan Message), SPL (Supplementary |
| | Flight Plan Message) |
| Control | Control Clearance Message, Control Transfer Message, |
| Message | Flow Control Message, Position Report and Aircraft Report |
| | Message |

The flight plan tracing unit 140 displays and traces a flight plan status included in the flight plan status transition structure based on the set flight plan status.

The output unit 150 outputs the flight plan status transition structure in which the flight plan status is displayed. In more detail, the output unit 150 outputs the flight plan status transition structure at once and displays the set flight plan status in the status transition structure in real time, such that a system developer, a manager, and a controller may easily monitor the flight plan status.

The flight plan information management unit 160 stores and manages flight plan information, state change information of the flight plan and final state change time information of the flight plan. In this case, the flight plan information represents flight plan basic information and flight plan time information which are previously received through the input unit 110, the state change information of the flight plan represents current flight plan status information of aircraft, and the final state change time information of the flight plan represents time information having a current flight plan status of aircraft changed.

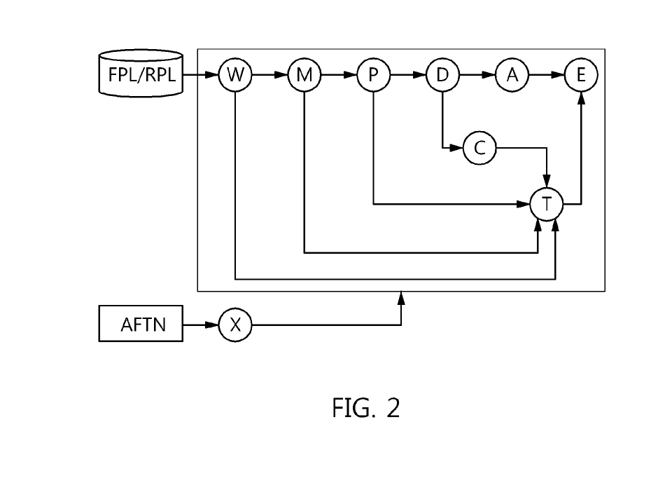

FIG. 2 is a diagram for describing a flight plan status transition structure according to an exemplary embodiment of the present invention.

Referring to FIG. 2, the flight plan structure generation unit generates the flight plan status transition structure.

As illustrated in FIG. 2, the flight plan structure generation unit generates the flight plan status transition structure, which includes the flight plan status of any one of the first waiting W, the modeling M, the second prepared P, the departed D, the controlled C, the terminated T, the arrived A, and the deleted D, based on the flight plan information received from the flight plan input unit (flight plan list (FPL) and repetitive flight plan list (RPL)). In this case, the first waiting represents a waiting status before the flight plan information is received, the modeling represents a status in which the flight plan information is received, the second prepared represents a waiting status after the flight plan information is received, the departed represents a status in which aircraft departs from a departure, the controlled represents a state in which a control right is handed-off before aircraft enters a destination, the terminated represents a status in which a navigation of aircraft is terminated, the arrived represents a status in which an aircraft arrives at a destination, and the deleted represents a status in which a flight plan corresponding to the arrived aircraft is deleted. The flight plan status may be traced based on a flight message X which is transferred from an aeronautical fixed telecommunication network (AFN) based on the so generated flight plan status transition structure.

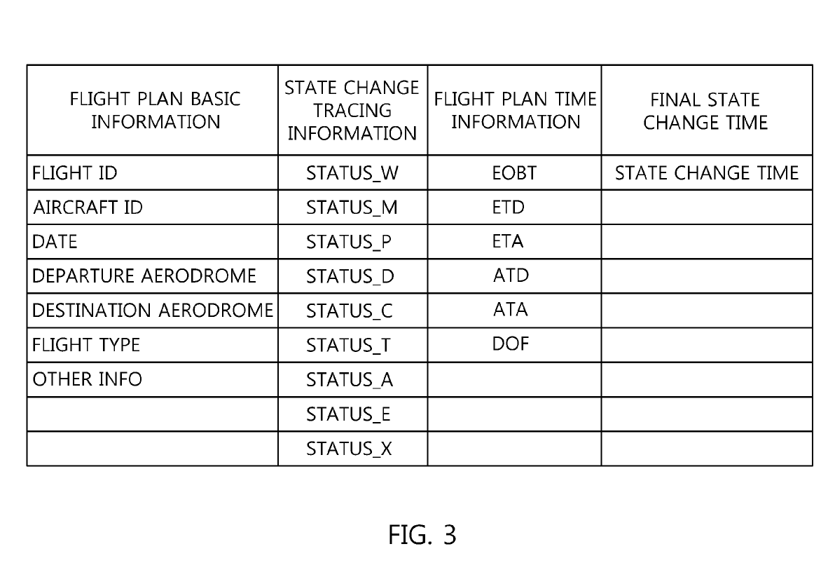

FIG. 3 is a diagram for describing the flight plan management information which is stored and managed in the apparatus for tracing a flight plan status according to the exemplary embodiment of the present invention.

Referring to FIG. 3, the flight plan information management unit according to the exemplary embodiment of the present invention stores and manages the flight plan information, the state change information of the flight plan, and the final state change time information of the flight plan.

The flight plan information management unit stores the flight plan information, the state change information of the flight plan, and the final state change time information of the flight plan in a database table configured as illustrated in FIG. 3. In this case, the flight plan basic information table stores any one of the flight identifier (flight ID), the aircraft identifier (Aircraft ID), the flight plan input date (Date), the departure aerodrome, the destination aerodrome, the flight type, and other flight plan information. Further, the state change tracing information table which is information on the current aircraft status stores information of any one of first waiting STATUS_W, modeling STATUS_M, second prepared STATUS_P, departure STATUS_D, controlled STATUS_C, terminated STATUS_T, arrived STATUS_A, deleted STATUS_D, and flight message STATUS_X. Further, the flight plan time information table stores any one of the estimated off block time (EOBT), the estimated time of departure (ETD), the estimated time of arrival (ETA), the actual time of departure (ATD), the actual time of arrival (ATA), and the date of flight (DOF). The final state change time table stores the current state change time.

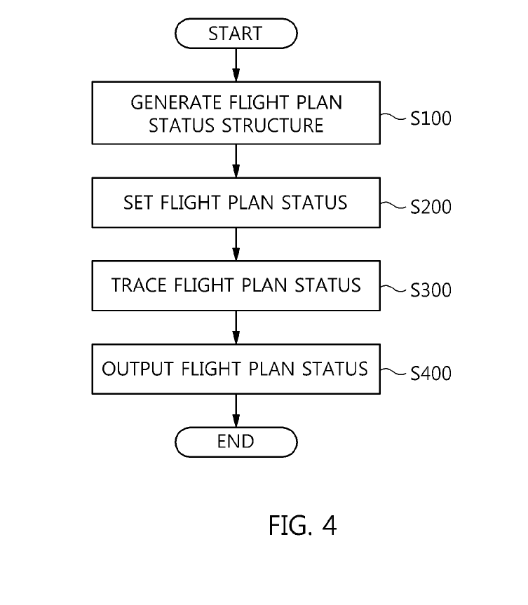

FIG. 4 is a flow chart for describing a method for tracing a flight plan status according to an exemplary embodiment of the present invention.

Referring to FIG. 4, the method for tracing a flight plan status according to the exemplary embodiment of the present invention uses the apparatus for tracing a flight plan status described above, and therefore the overlapping description thereof will be omitted below.

First, the flight plan status transition structure is generated based on the flight plan information (S100). In S100, the flight plan basic information including any one of the flight identifier, the aircraft identifier, the flight plan input date, the departure aerodrome, the destination aerodrome, the flight type, and other flight plan information is received and then the flight plan status transition structure including the flight plan status of any one of the first waiting, the modeling, the second prepared, the departed, the controlled, the terminated, the arrived, and the deleted is generated based on the received flight plan basic information.

Next, the flight plan status is set based on the flight message transferred through the aeronautical fixed telecommunication network (S200). In S200, the flight plan status is set based on the flight message including any one of the emergency message, the aircraft moving message, the coordination message, the supplementary flight plan message, and the control message.

Next, the flight plan status included in the flight status transition structure is displayed and traced based on the set flight plan status (S300). In S300, the set flight plan status is displayed in the flight plan status transition structure. The set flight plan status is differently displayed in the flight plan status transition structure each time the flight plan status is changed.

Finally, the flight plan status transition structure and the set flight plan status are output (S400). In S400, the flight plan status transition structure is output at once and the set flight plan status is displayed in the status transition structure in real time, such that the system developer, the manager, and the controller may easily monitor the flight plan status.

As such, the apparatus and the method for tracing a flight plan status according to the exemplary embodiment of the present invention provides the flight plan status transition structure for tracing the flight plan status in real time, thereby confirming the normality and abnormality of the flight plan and the flight massage processing.

Further, according to the exemplary embodiment of the present invention, the status tracing and monitoring of the total life-cycle of the flight plan may be carried out by displaying the flight plan status transition structure for tracing the flight plan status at once.

In accordance with the present invention, the apparatus and the method for tracing a flight plan status may provide the flight plan status transition structure for tracing the life-cycle of the flight plan status in real time, thereby confirming the normality and abnormality of the flight plan and the flight massage processing.

Further, according to the exemplary embodiment of the present invention, the tracing and monitoring of the flight plan status may be easily carried out by displaying the flight plan status transition structure for tracing the flight plan status at once.

Hereinabove, the exemplary embodiments of the present invention are described but may be variously changed and various changed examples and modified examples may be practiced by a person having ordinary skill in the art to which the present invention pertains without departing from claims of the present invention.

What is claimed is:

1. An apparatus for tracing a flight plan status, comprising:
a flight plan structure generation unit configured to generate a flight plan status transition structure based on received flight plan information;
a flight plan setting unit configured to set a flight plan status based on a flight message transferred through an aeronautical fixed telecommunication network; and
a flight plan tracing unit configured to display and trace the flight plan status included in the flight plan status transition structure based on the set flight plan status.

2. The apparatus of claim 1, wherein the flight plan information includes flight plan basic information which includes any one of a flight plan identifier, an aircraft identifier, a flight plan input date and time, a departure aerodrome, a destination aerodrome, a flight plan type, and other flight plan information and flight plan time information which includes moving start time for aircraft departure, estimated time of departure, estimated time of arrival, actual time of departure, actual time of arrival, and a date of flight.

3. The apparatus of claim 1, wherein the flight plan structure generation unit generates the flight plan status transition structure which includes a flight plan status of any one of first waiting, modeling, second prepared, departed, controlled, terminated, arrived, and deleted.

4. The apparatus of claim 3, wherein the first waiting represents a waiting status before the flight plan information is received and the second prepared represents a waiting status after the flight plan information is received.

5. The apparatus of claim 3, wherein the flight plan structure generation unit generates the flight plan status transition structure which includes the controlled branched from the departed.

6. The apparatus of claim 5, wherein the flight plan structure generation unit generates the flight plan status transition structure which includes the first waiting, the modeling, the second prepared, and the terminated branched from the controlled.

7. The apparatus of claim 1, wherein the flight message includes any one of an emergency message, an aircraft moving message, a coordination message, a supplementary flight plan message, and a control message.

8. The apparatus of claim 1, further comprising:
a flight plan information management unit configured to store and manage the flight plan information, state change information of a flight plan, and final state change time information of the flight plan.

9. The apparatus of claim 1, further comprising:
an output unit configured to output the flight plan status transition structure at once and display and monitor the set flight plan status in the status transition structure in real time.

10. A method for tracing a flight plan status, comprising:
generating, by a flight plan structure generation unit, a flight plan status transition structure based on received flight plan information;
setting, by a flight plan setting unit, a flight plan status based on a flight message transferred through an aeronautical fixed telecommunication network; and
displaying and tracing, by a flight plan tracing unit, the flight plan status included in the flight plan status transition structure based on the set flight plan status.

11. The method of claim 10, wherein in the generating of the flight plan status transition structure based on the received flight plan information, the flight plan status transition structure which includes a flight plan status of any one of first waiting before a flight plan is received, modeling, second prepared after the flight plan is received, departed, controlled, terminated, arrived, and deleted is generated.

12. The method of claim 10, wherein in the setting of the flight plan status based on the flight message transferred through the aeronautical fixed telecommunication network, the flight plan status is set based on the flight message which includes any one of an emergency message, an aircraft moving message, a coordination message, a supplementary flight plan message, and a control message.

13. The method of claim 10, further comprising:
after the displaying and tracing of the flight plan status included in the flight plan status transition structure based on the set flight plan status, outputting the flight plan status transition structure at once and displaying and monitoring the set flight plan status in the status transition structure in real time.
